(19) United States
(12) Patent Application Publication
(10) Pub. No.: US 2019/0260887 A1
(43) Pub. Date: Aug. 22, 2019

(54) INFORMATION PROCESSING APPARATUS, INFORMATION PROCESSING SYSTEM, AND NON-TRANSITORY COMPUTER READABLE MEDIUM

(71) Applicant: FUJI XEROX CO.,LTD., Tokyo (JP)

(72) Inventor: Yoshiyuki YODA, Kanagawa (JP)

(73) Assignee: FUJI XEROX CO.,LTD., Tokyo (JP)

(21) Appl. No.: 16/274,243

(22) Filed: Feb. 13, 2019

(30) Foreign Application Priority Data
Feb. 21, 2018 (JP) 2018-029078

(51) Int. Cl. H04N 1/00

(52) U.S. Cl. CPC H04N 1/00413; H04N 1/00037; H04N 1/0001; H04N 1/00005

(57) ABSTRACT

An information processing apparatus includes a determining unit that determines an information processing apparatus state realized while a bypass operation to bypass a particular fault is not being performed and a changing unit that changes, when it is no longer necessary to perform the bypass operation while the bypass operation is being performed, a current information processing apparatus state to the information processing apparatus state that is determined by the determining unit and that is realized while the bypass operation is not being performed.

### CROSS-REFERENCE TO RELATED APPLICATIONS

This application is based on and claims priority under 35 USC 119 from Japanese Patent Application No. 2018-029078 filed Feb. 21, 2018.

### BACKGROUND

### (i) Technical Field

The present disclosure relates to an information processing apparatus, an information processing system, and a non-transitory computer readable medium.

### (ii) Related Art

It is known in the related art that, when an image processing apparatus having predetermined functions detects a service call error that originates inside the apparatus and that allows normal operation under the condition in which a certain function of the apparatus is restricted, a screen including a function restriction key to restrict the functions of the apparatus is displayed (for example, refer to Japanese Patent No. 4393006).

### SUMMARY

If an apparatus adopts a configuration to merely perform a bypass operation to bypass a particular fault, when it is no longer necessary to perform the bypass operation, the apparatus is not allowed to change to a state realized while the bypass operation is not being performed.

Aspects of a non-limiting embodiment of the present disclosure relate to enabling an apparatus to change, when it is no longer necessary to perform a bypass operation to bypass a particular fault, to a state realized while the bypass operation is not being performed.

Aspects of a certain non-limiting embodiment of the present disclosure overcome the above disadvantages and/or other disadvantages not described above. However, aspects of the non-limiting embodiment are not required to overcome the disadvantages described above, and aspects of the non-limiting embodiment of the present disclosure may not overcome any of the disadvantages described above.

According to an aspect of the present disclosure, there is provided an information processing apparatus including a determining unit that determines an information processing apparatus state realized while a bypass operation to bypass a particular fault is not being performed and a changing unit that changes, when it is no longer necessary to perform the bypass operation while the bypass operation is being performed, a current information processing apparatus state to the information processing apparatus state that is determined by the determining unit and that is realized while the bypass operation is not being performed.

### BRIEF DESCRIPTION OF THE DRAWINGS

An exemplary embodiment of the present disclosure will be described in detail based on the following figures, wherein:

FIG. 1 depicts an example of an overall configuration of an image processing system according to an exemplary embodiment of the present disclosure;

FIG. 2 is a diagram illustrating an example of a hardware configuration of an image processing apparatus to which the present exemplary embodiment is applied;

FIG. 3 is a diagram illustrating an example of a hardware configuration of a portable terminal to which the present exemplary embodiment is applied;

FIG. 4 is a block diagram illustrating an example of a functional configuration of the image processing apparatus according to the exemplary embodiment of the present disclosure;

FIG. 5 is a block diagram illustrating an example of a functional configuration of the portable terminal according to the exemplary embodiment of the present disclosure;

FIG. 6 depicts an example of an error notification screen displayed by the image processing apparatus according to the exemplary embodiment of the present disclosure;

FIG. 7 is a flowchart illustrating a processing flow of an application on the portable terminal in the case where an error has occurred in the image processing apparatus according to the exemplary embodiment of the present disclosure;

FIG. 8 depicts an example of a bypass method selection screen displayed by the portable terminal according to the exemplary embodiment of the present disclosure; and

FIG. 9 is a sequence diagram illustrating a processing flow of an application on the image processing apparatus and the portable terminal and depicts the processing flow after an error that has occurred in the image processing apparatus according to the exemplary embodiment of the present disclosure is fixed.

### DETAILED DESCRIPTION

Hereinafter, an exemplary embodiment of the present disclosure will be described in detail with reference to the attached drawings.

### Overall Configuration of Image Processing System

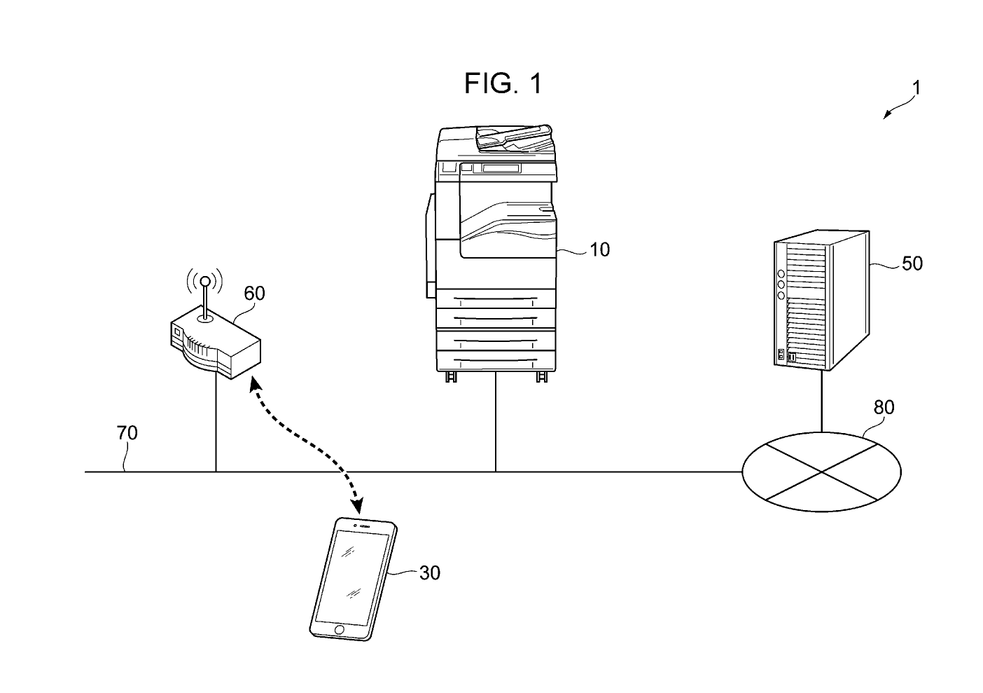

FIG. 1 depicts an example of an overall configuration of an image processing system 1 according to an exemplary embodiment. As depicted, the image processing system 1 is constituted such that an image processing apparatus 10 is connected to a communication network 70, such as an Ethernet (registered trademark) network, to which a portable terminal 30 is connected via a wireless access point 60 and a server 50 is connected via a communication network 80, such as the Internet.

The image processing apparatus 10 is an apparatus that performs image processing including image forming on and image reading from a recording medium, such as a sheet of paper, and image transmission to and image reception from a public network. However, the image processing apparatus 10 may be an apparatus that performs at least one of the functions described here. For example, the image processing apparatus 10 is considered to be a printer in view of performing only image forming, a scanner in view of performing only image reading, a copier in view of performing image reading and image forming, or a facsimile in view of performing image reading and transmission or performing image reception and forming. According to the present exemplary embodiment, the image processing apparatus 10 is disposed as an example of an information processing apparatus and as an example of the second information processing apparatus.

The portable terminal 30 is a computer apparatus used by a user of the image processing apparatus 10. Changing various settings for a temporary operational change of the image processing apparatus 10 and restoring the settings after completion of the temporary operational change are cumbersome for a user, and thus the portable terminal 30 supports such operations. Connection to the server 50 via the communication network 80, such as the Internet, is required to support such operations. However, external connection of the image processing apparatus 10 is not allowed in some cases from a security policy viewpoint, and the portable terminal 30 is used in this respect. The portable terminal 30 is desirably realized, for example, by a smartphone. According to the present exemplary embodiment, the portable terminal 30 is disposed as an example of the first information processing apparatus.

The server 50 is a computer apparatus disposed in a support center that provides support for a change in settings, restoration of settings, and the like of the image processing apparatus 10. The server 50 enables realization, on the communication network 80, such as the Internet, of a supplier site of a supplier that performs such support.

### Hardware Configuration of Image Processing Apparatus

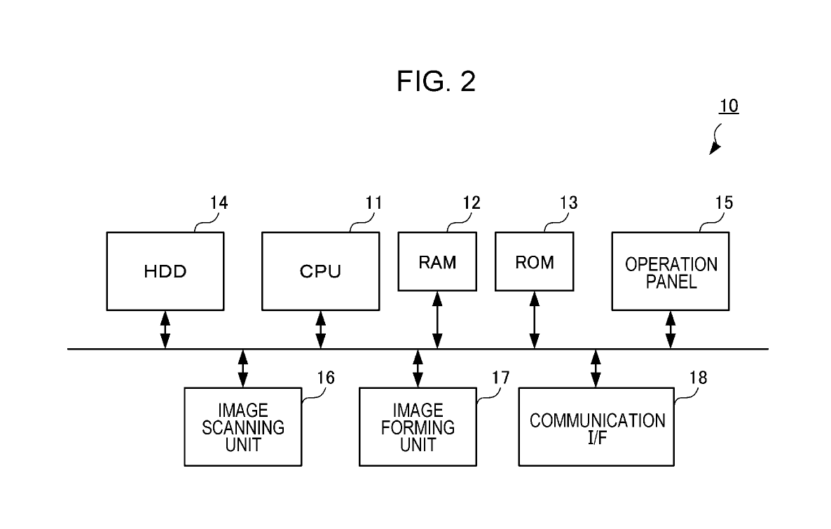

FIG. 2 is a diagram illustrating an example of a hardware configuration of the image processing apparatus 10 to which the present exemplary embodiment is applied. As depicted, the image processing apparatus 10 includes a central processing unit (CPU) 11, a random access memory (RAM) 12, a read-only memory (ROM) 13, a hard disk drive (HDD) 14, an operation panel 15, an image scanning unit 16, an image forming unit 17, and a communication interface (hereinafter, referred to as a communication I/F) 18.

The CPU 11 loads various programs stored in the ROM 13 and the like into the RAM 12 and executes the programs to realize various functions described below.

The RAM 12 is a memory used as a working memory or the like by the CPU 11.

The ROM 13 is a memory that stores various programs to be run by the CPU 11.

The HDD 14 is, for example, a magnetic disk apparatus that stores image data scanned by the image scanning unit 16, image data to be used for image forming by the image forming unit 17, and the like.

The operation panel 15 is a touch panel that displays various pieces of information and that accepts an input operation from a user. The operation panel 15 includes a display, which is an example of a display screen on which various pieces of information are displayed, and a position detection sheet that detects a position to which a pointing device, such as a finger or a stylus pen, points.

The image scanning unit 16 is an example of an image processing unit and scans an image recorded on a recording medium, such as a sheet of paper. The image scanning unit 16 is, for example, a scanner, and a scanner that uses a lens to reduce the size of an optical image formed by light reflected by a document, which is irradiated by a light source, and that uses a charge coupled device (CCD) to receive the reflected light, which is called a CCD-type unit, or a scanner that uses a contact image sensor (CIS) to receive light reflected by a document, which is irradiated sequentially by a light emitting diode (LED) source, which is called a CIS-type unit, is desirably used.

The image forming unit 17 is an example of an image processing unit and forms an image on a recording medium. The image forming unit 17 is, for example, a printer, and a printer that transfers toner attached to a photosensitive member onto a recording medium to form an image, which is called an electrophotographic-type unit, or a printer that discharges ink onto a recording medium to form an image, which is called an inkjet-type unit, is desirably used.

The communication I/F 18 transmits various pieces of information to other apparatuses via a network and receives various pieces of information from other apparatuses via a network.

### Hardware Configuration of Portable Terminal

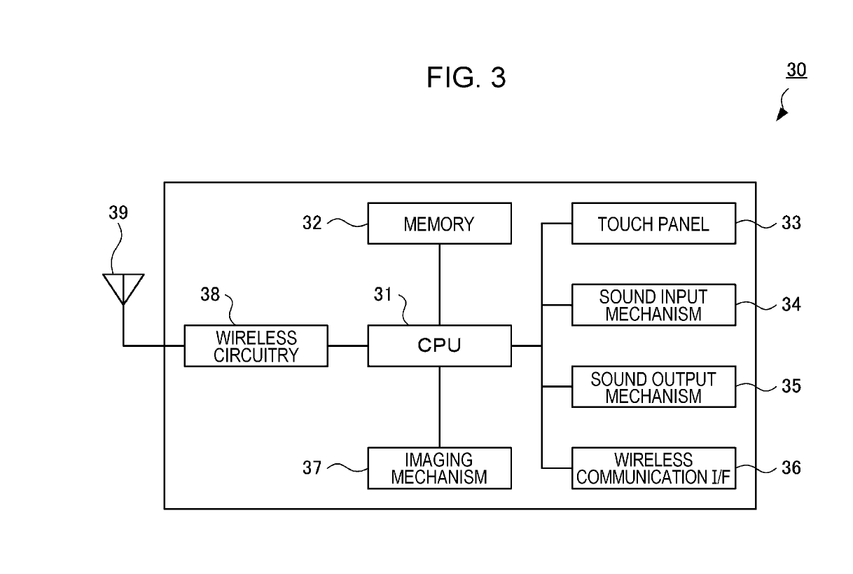

FIG. 3 is a diagram illustrating an example of a hardware configuration of the portable terminal 30 according to the present exemplary embodiment. As depicted, the portable terminal 30 includes a CPU 31, which is a calculating unit, a memory 32, which is a storing unit, a touch panel 33, which displays various pieces of information and accepts an input operation from a user, a sound input mechanism 34, such as a microphone, a sound output mechanism 35, such as a speaker, and a wireless communication I/F 36, which transmits and receives various pieces of information via wireless communication, such as Wireless Fidelity (Wi-Fi, registered trademark). The portable terminal 30 also includes an imaging mechanism 37, which includes a camera that captures a subject. In addition, the portable terminal 30 includes wireless circuitry 38 and an antenna 39 to communicate wirelessly via a base station. The wireless circuitry 38 includes a baseband LSI, which is not depicted, which processes digital data signals to be transmitted or received wirelessly.

### Outline of Exemplary Embodiment

According to the present exemplary embodiment, in such an image processing system, the image processing apparatus 10 determines an image processing apparatus 10 state realized while a bypass operation to bypass a particular fault is not being performed and changes, when it is no longer necessary to perform the bypass operation while the bypass operation is being performed, a current image processing apparatus 10 state to the image processing apparatus 10 state realized while the bypass operation is not being performed. An example of the image processing apparatus 10 state realized while the bypass operation is not being performed is an image processing apparatus 10 state realized before the bypass operation is performed. Hereinafter, an error is assumed as an example of a particular fault, and image processing apparatus 10 settings effective while a bypass operation is not being performed are assumed to denote an example of an image processing apparatus 10 state realized while a bypass operation is not being performed. Next, details will be described by assuming that the image processing apparatus 10 settings are determined by reading an image processing apparatus 10 state stored before the bypass operation is performed.

### Functional Configuration of Image Processing Apparatus

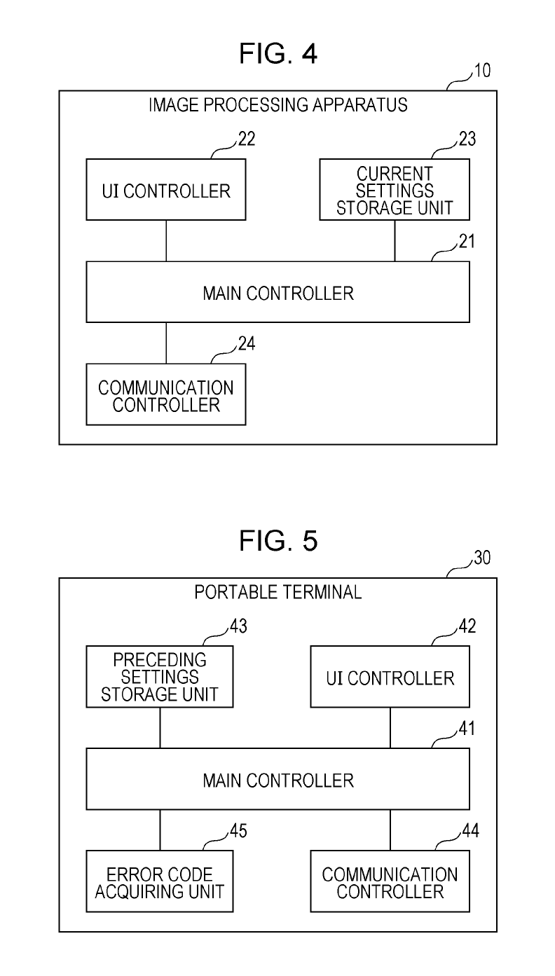

FIG. 4 is a block diagram illustrating an example of a functional configuration of the image processing apparatus 10 according to the present exemplary embodiment. As depicted, the image processing apparatus 10 includes a main controller 21, a user interface (UI) controller 22, a current settings storage unit 23, and a communication controller 24.

The main controller 21 controls display and acceptance of information performed by the UI controller 22 and transmission and reception of information performed by the communication controller 24. The main controller 21 also writes information to the current settings storage unit 23 and reads information from the current settings storage unit 23. For example, when the image processing apparatus 10 performs a bypass operation, the main controller 21 reads settings at the present time (hereinafter, referred to as “current settings”) stored in the current settings storage unit 23 to transmit to the portable terminal 30. When it is no longer necessary to perform a bypass operation, the main controller 21 replaces current settings stored in the current settings storage unit 23 with settings that are effective before the bypass operation is performed, that is, settings that are effective before a change is effected (hereinafter, referred to as “preceding settings”). In the present exemplary embodiment, current settings are used as an example of a current image processing apparatus 10 state, and preceding settings are used as an example of an image processing apparatus 10 state realized while a bypass operation is not being performed. Further, the main controller 21 is disposed as an example of a changing unit that changes a current image processing apparatus 10 state to an image processing apparatus 10 state realized while a bypass operation is not being performed.

The UI controller 22 controls information display on the operation panel 15 and information acceptance from the operation panel 15.

The current settings storage unit 23 stores current settings, which are current image processing apparatus 10 settings.

The communication controller 24 controls transmission and reception of information via the communication I/F 18. For example, when the image processing apparatus 10 performs a bypass operation, the communication controller 24 controls current settings to be transmitted to the portable terminal 30 via the communication I/F 18. When a bypass operation is no longer necessary, the communication controller 24 controls preceding settings to be received from the portable terminal 30 via the communication I/F 18. In the present exemplary embodiment, the communication controller 24 is disposed as an example of a determining unit that determines an image processing apparatus 10 state realized while a bypass operation to bypass a particular fault is not being performed.

### Functional Configuration of Portable Terminal

FIG. 5 is a block diagram illustrating an example of a functional configuration of the portable terminal 30 according to the present exemplary embodiment. As depicted, the portable terminal 30 includes a main controller 41, a UI controller 42, a preceding settings storage unit 43, a communication controller 44, and an error code acquiring unit 45.

The main controller 41 controls display and acceptance of information performed by the UI controller 42 and transmission and reception of information performed by the communication controller 44. For example, when the image processing apparatus 10 performs a bypass operation, if a user is required to perform an operation to change a setting parameter on a client that provides instructions on printing to the image processing apparatus 10, the main controller 41 controls the UI controller 42 to display guiding information regarding the way to change the setting parameter. When it is no longer necessary to perform the bypass operation, if the user is required to perform an operation to restore a setting parameter, the main controller 41 controls the UI controller 42 to display guiding information regarding the way to restore the setting parameter. In this case, the client is an example of another apparatus, and the main controller 41 is an example of a determining unit that determines the state of another apparatus. The main controller 41 also writes information to the preceding settings storage unit 43 and reads information from the preceding settings storage unit 43. For example, when the image processing apparatus 10 performs a bypass operation, the main controller 41 stores current settings received from the image processing apparatus 10 in the preceding settings storage unit 43 as preceding settings. Further, when it is no longer necessary to perform the bypass operation, the main controller 41 reads the preceding settings stored in the preceding settings storage unit 43 to transmit to the image processing apparatus 10.

The UI controller 42 controls information display on the touch panel 33 and information acceptance from the touch panel 33.

The preceding settings storage unit 43 stores preceding settings, which are image processing apparatus 10 settings that are effective before the image processing apparatus 10 performs a bypass operation.

The communication controller 44 controls transmission and reception of information via the wireless communication I/F 36. For example, when the image processing apparatus 10 performs a bypass operation, the communication controller 44 controls current settings to be received from the image processing apparatus 10 via the wireless communication I/F 36. When a bypass operation is no longer necessary, the communication controller 44 controls preceding settings to be transmitted to the image processing apparatus 10 via the wireless communication I/F 36.

The error code acquiring unit 45 acquires the error code of an error that has occurred in the image processing apparatus 10. For example, the error code may be acquired from an image captured by the imaging mechanism 37.

### Operation of Image Processing System

When processing such as printing is performed and an error is detected, the image processing apparatus 10 displays an error notification screen on the operation panel 15 to provide notification of an error occurrence.

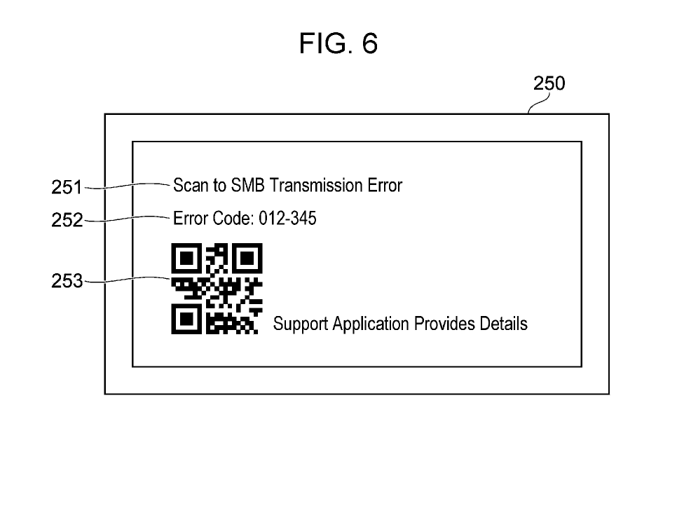

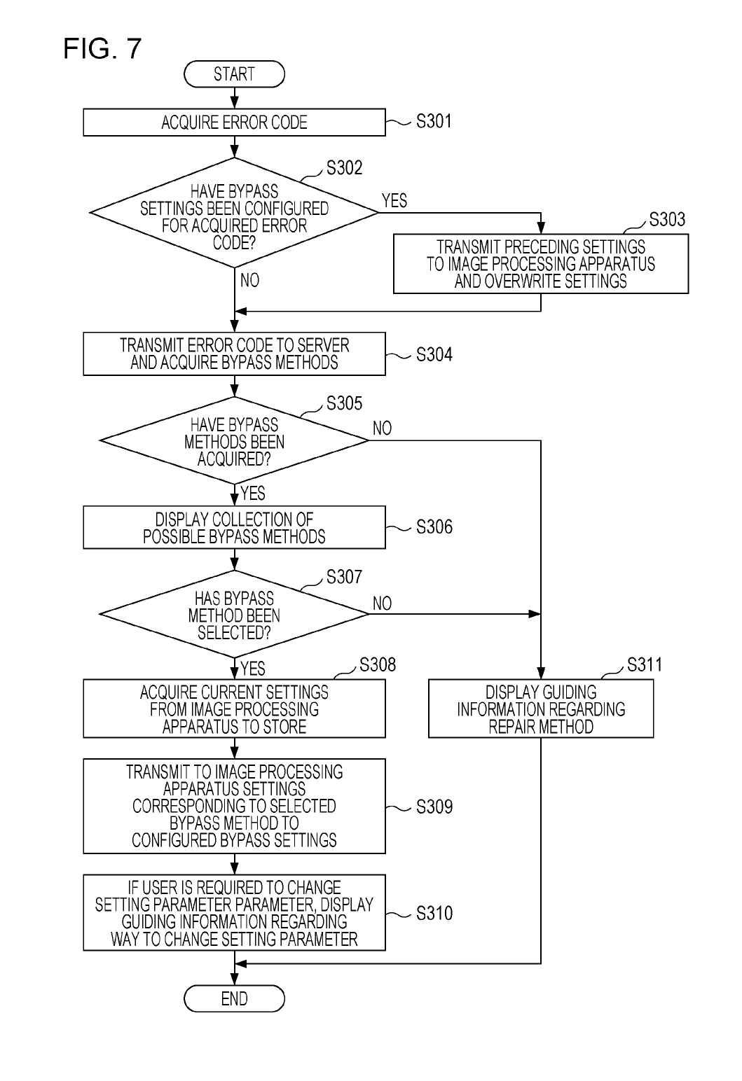

FIG. 6 depicts an example of an error notification screen 250 displayed on the operation panel 15 by the image processing apparatus 10. As depicted, the error notification screen 250 includes a text portion 251, a text portion 252, and a quick response (QR) code (registered trademark) 253. Of these portions, the text portion 251 represents the name of an error, and the text portion 252 represents the error code. The error code is also encoded and embedded in the QR code (registered trademark) 253.

When the error notification screen 250 is displayed on the operation panel 15 of the image processing apparatus 10 as depicted, a user starts an application, which is installed in advance, on the portable terminal 30. An “application” mentioned here indicates a software tool, which is provided by a supplier, to configure settings to bypass an error (hereinafter, referred to as “bypass settings”).

FIG. 7 is a flowchart illustrating a processing flow of an application on the portable terminal 30 in the case where an error has occurred in the image processing apparatus 10.

When a user uses this application to control the imaging mechanism 37 and captures the QR code (registered trademark) 253 on the error notification screen 250, the error code acquiring unit 45 in the portable terminal 30 acquires the error code from the scanned image (step S301). In this case, it is assumed that the image processing apparatus 10 displays the QR code (registered trademark) 253 and that the portable terminal 30 reads the QR code by using the imaging mechanism 37 and acquires the error code, but this is not to be considered as limiting. For example, the user may view the text portion 252 and may input the error code manually by using the touch panel 33, and the portable terminal 30 may then acquire the error code. Alternatively, the user may view the text portion 252 and may select the error code among candidate error codes displayed by the portable terminal 30, and the portable terminal 30 then acquires the error code. Instead, the portable terminal 30 may acquire the error code from the image processing apparatus 10 by communicating via Wi-Fi.

Next, the main controller 41 determines whether bypass settings have been configured for the error code acquired in step S301 (step S302).

If it is determined that bypass settings have not been configured for the acquired error code, the main controller 41 controls the communication controller 44 to transmit the error code to the server 50 and acquires bypass methods corresponding to the error code (step S304). Specifically, the portable terminal 30 transmits the error code to the server 50 via the wireless communication I/F 36 and receives bypass methods from the server 50. The server 50 may acquire bypass methods corresponding to the error code from a database prepared in advance or may use artificial intelligence (AI) to acquire bypass methods from a database of past cases.

Next, the main controller 41 determines whether bypass methods corresponding to the error code have been acquired (step S305).

Upon determining that bypass methods corresponding to the error code have been acquired, the main controller 41 controls the UI controller 42 to display a collection of possible bypass methods on the touch panel 33 (step S306). Each bypass method in the collection of possible bypass methods includes a restriction. This is because, when some unit, service, or function is stopped or settings are changed to alternative settings, a limitation or a restriction is sometimes imposed on the operation, or a user sometimes needs to change the surrounding environment.

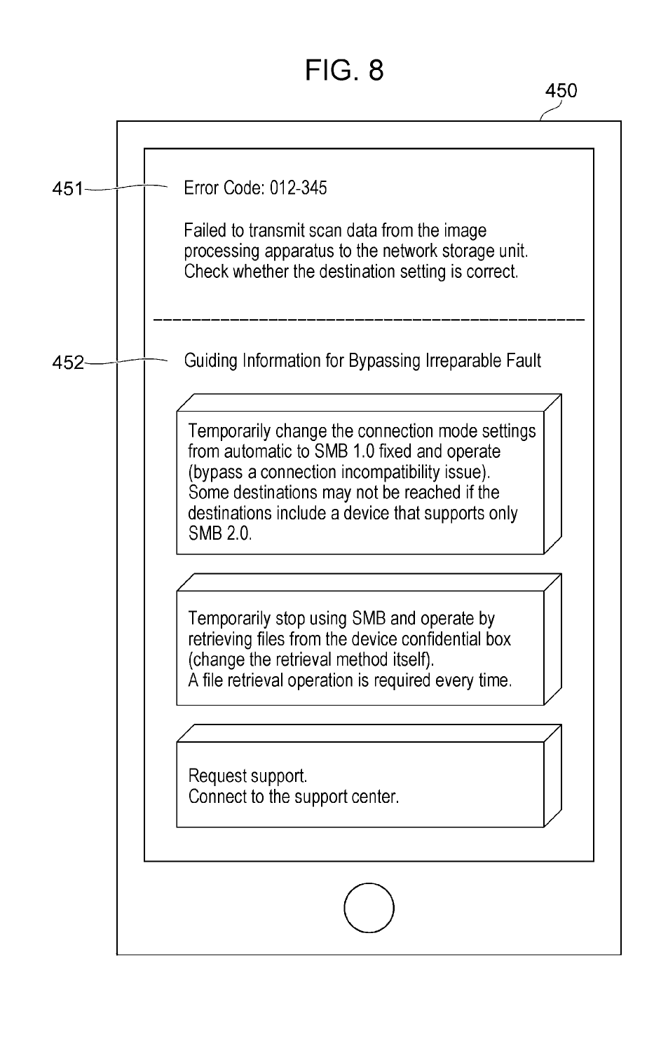

FIG. 8 depicts an example of a bypass method selection screen 450 displayed on the touch panel 33 by the portable terminal 30. As depicted, the bypass method selection screen 450 includes an error display section 451 and a bypass method display section 452.

The error display section 451 indicates that the bypass method selection screen 450 is a screen that is displayed when a Scan to Server Message Block (SMB) transmission error has occurred. The Scan to SMB transmission error occurs when a connection fails to be established because of a compatibility issue in the SMB protocol.

The bypass method display section 452 displays as the first option a message stating that the automatic SMB discrimination settings are changed to “SMB 1.0 fixed”. This message indicates that the image processing apparatus 10 changes the settings to use SMB 1.0 without negotiation. The bypass method display section 452 also displays a message stating that some destinations may not be reached if the destinations include a device that supports only SMB 2.0, which is a restriction imposed when this option is selected.

Further, the bypass method display section 452 displays as the second option a message stating that the scan mode is changed to a confidential box scan mode. This message indicates that the image processing apparatus 10 changes the destination from individual addresses to a confidential box in the image processing apparatus 10. The bypass method display section 452 also displays a message stating that scan data needs to be retrieved from the confidential box, which is a restriction imposed when this option is selected.

Here, it is assumed that the bypass method selection screen 450 is a screen for selecting a bypass method that changes relevant settings to provide a final output instead of providing a simple alternative. However, such a bypass method is not limited to the above example and may be an example described below.

For example, the bypass method selection screen 450 may be a screen in the case where an Ethernet (registered trademark) communication failure occurs. An Ethernet (registered trademark) communication failure occurs when a link state is unstable due to a compatibility issue of a hub and the transmission speed is slow.

In such a case, the bypass method display section 452 may display as the first option a message stating that the link speed is limited to 10 Mbps or 100 Mbps. This message indicates that the image processing apparatus 10 changes the settings so that the link is established without using a Gbps speed. The bypass method display section 452 may also display a message stating that, when high-capacity communication is required, the performance of the image processing apparatus 10 sometimes does not reach the level that is achievable without the limitation applied to the link speed, which is a restriction imposed when this option is selected.

Further, the bypass method display section 452 may display as the second option a message prompting a user to change the main body or the port of a hub to which the image processing apparatus 10 is connected. This message indicates that the user is required to make such a change. Then, the bypass method display section 452 may display a message stating that the network administrator is required to handle this change, which is a restriction imposed when this option is selected.

Alternatively, the bypass method selection screen 450 may be a screen in the case where a printing failure in the LPR port occurs. The printing failure in the LPR port occurs when printing data is not output from a client because of an invalid simple network management protocol (SNMP) status.

In such a case, the bypass method display section 452 may display as the first option a message prompting a user to change the SNMP settings of the LPR port on the client side to the off state. This message indicates that the user is required to make such a change. Then, the bypass method display section 452 may display a message stating that this option does not allow the state of the printer to be acquired and displayed on the client side, which is a restriction imposed when this option is selected.

Further, the bypass method display section 452 may display as the second option a message prompting a user to change the printing protocol type on the client side to port 9100. This message indicates that the user is required to make such a change. Then, the bypass method display section 452 may display a message stating that the settings of the printer output destination need to be changed on the client side, which is a restriction imposed when this option is selected.

Alternatively, the bypass method selection screen 450 may be a screen in the case where a duplex printing unit has failed.

In such a case, the bypass method display section 452 may display as the first option a message stating that the image processing apparatus 10 is set to print images placed on two pages on one sheet (hereinafter, referred to as “2-up printing”) and prints images on one side. This message indicates that the image processing apparatus 10 changes the settings for duplex printing to the settings for 2-up printing. The bypass method display section 452 may display a message stating that printed text is sometimes difficult to read due to size reduction, which is a restriction imposed when this option is selected.

Further, the bypass method display section 452 may display as the second option a message stating that two sheets, each of which has a printed page on one side only, are output. This message indicates that the image processing apparatus 10 changes the settings for duplex printing to the settings for one-sided printing. The bypass method display section 452 may display a message stating that the number of sheets that are output increases and billing management is affected, which is a restriction imposed when this option is selected.

Thus, after the collection of possible bypass methods is displayed on the touch panel 33 in step S306, the portable terminal 30 waits for a user to respond to the display on the touch panel 33 and to make a selection. This is because limitations or restrictions are sometimes imposed on the operation or because the user is sometimes required to change the surrounding environment as described above, and thus obtaining approval from the user or the administrator is required. Specifically, the main controller 41 controls the UI controller 42 and determines whether a bypass method has been selected from the collection of the possible bypass methods displayed on the touch panel 33 (step S307).

Upon determining that a bypass method has been selected, the main controller 41 acquires current settings from the image processing apparatus 10 and stores the current settings in the preceding settings storage unit 43 before the operation in accordance with the selected bypass method is started (step S308). Specifically, the main controller 21 reads the current settings from the current settings storage unit 23 in the image processing apparatus 10, and the portable terminal 30 receives the current settings from the image processing apparatus 10 via the wireless communication I/F 36 and stores the current settings in the preceding settings storage unit 43. Realizing the preceding settings storage unit 43 by using an application on the portable terminal 30 in this manner requires no special handling by the image processing apparatus 10, and thus the present exemplary embodiment may be applied to image processing apparatus 10 units that have been shipped.

Subsequently, the main controller 41 transmits settings corresponding to the bypass method selected in step S307 to the image processing apparatus 10 and configures the bypass settings (step S309). Specifically, the portable terminal 30 transmits the settings to the image processing apparatus 10 via the wireless communication I/F 36. Thus, the image processing apparatus 10 receives the settings via the communication I/F 18, and the main controller 21 stores the settings in the current settings storage unit 23.

If a user is required to perform an operation to change a setting parameter on a client that provides instructions on printing to the image processing apparatus 10, the main controller 41 controls the UI controller 42 to display guiding information regarding the way to change the setting parameter on the touch panel 33 (step S310).

In contrast, if it is determined that no bypass method has been selected in step S307, the main controller 41 controls the UI controller 42 to display guiding information regarding a repair method on the touch panel 33 (step S311). Guiding information regarding a telephone call to a repair center who handles errors, an order for the components needed for the repair, and the like may be displayed.

A plurality of causes are sometimes inferred from errors that appear to be the same. In such a case, if the cause is not correctly inferred, configuring the selected bypass settings does not contribute to bypassing a fault, and an error occurs again. In this case, the selected bypass settings are canceled, and different bypass settings are tested.

That is, if it is determined in step S302 that the bypass settings have been configured for the acquired error code, the main controller 41 controls the communication controller 44 to transmit the preceding settings, which are stored in the preceding settings storage unit 43, to the image processing apparatus 10 and overwrites the current settings (step S303). Specifically, the portable terminal 30 transmits the preceding settings to the image processing apparatus 10 via the wireless communication I/F 36. Thus, the image processing apparatus 10 receives the preceding settings via the communication I/F 18, and the main controller 21 stores the preceding settings in the current settings storage unit 23.

Then, the portable terminal 30 repeats processing in steps S304 to S310.

In the above description, it is assumed that the user starts the application on the portable terminal 30 in response to the display of an error code by the image processing apparatus 10, but this is not to be considered as limiting. A fault that is not represented by an error code, such as disappearance of a process without causing an error or seemingly slow process execution or communication, also exists, and thus the user is desirably allowed to start the application on the portable terminal 30 any time.

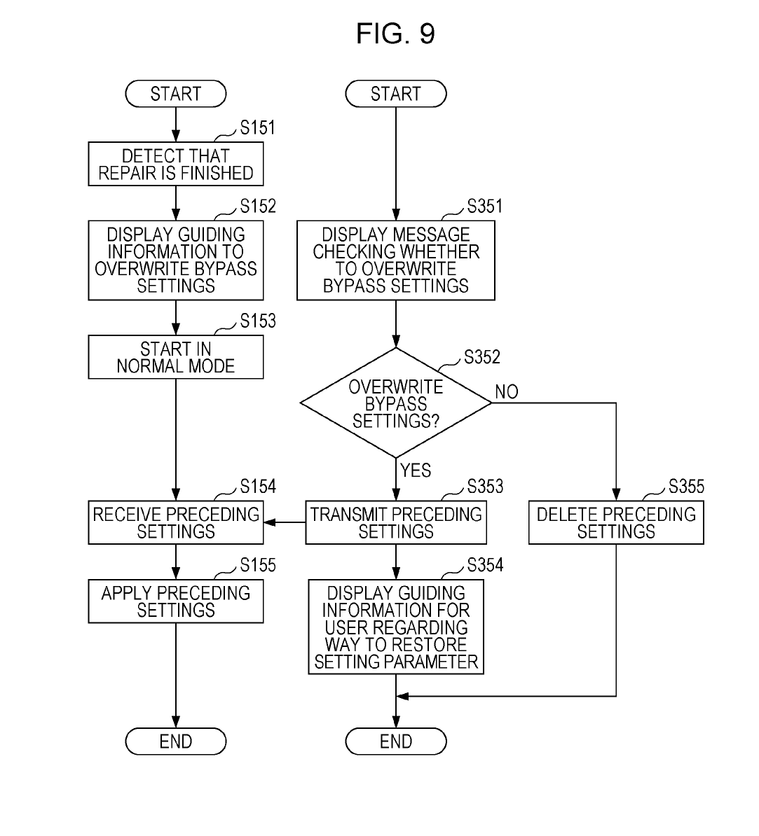

FIG. 9 is a sequence diagram illustrating a processing flow of the application on the image processing apparatus 10 and the portable terminal 30 and depicts the processing flow after an error that has occurred in the image processing apparatus 10 is fixed.

For example, it is assumed that a repair on the premise by a customer engineer (CE), a send-back repair in a repair center, or a repair by the user, such as parts replacement, has finished. Then, in the image processing apparatus 10, the main controller 21 detects that the repair of the image processing apparatus 10 is finished (step S151). Specifically, every time the image processing apparatus 10 is started, identifying information of each component or each piece of software in the image processing apparatus 10 is compared with identifying information acquired at the time point of the preceding start because a portion to be fixed varies depending on details of a fault. A piece of information for individual identification, such as a firmware version or a serial number of a board, is compared with a piece of information acquired at the time point of the preceding start, and the repair completion is detected. A revision number or the like for machine management, which changes every time repair work is carried out, may be used to detect the repair completion. Alternatively, a database for coping with failures may be prepared and searched.

For example, in the case of a Scan to SMB transmission error, an Ethernet (registered trademark) communication failure, or a printing failure in the LPR port, when the image processing apparatus 10 is started with a firmware version different from the version at the fault occurrence, it may be determined that the repair has been carried out. Further, in the case of a failure in the duplex printing unit, when the serial number of the duplex printing unit at the start is found to differ from the serial number at the fault occurrence, it may be determined that the repair has been carried out.

Next, the main controller 21 controls the UI controller 22 to display on the operation panel 15 a message requesting the user to input into the application on the portable terminal 30 the decision whether to overwrite the bypass settings to restore the state that is realized before the operation based on the bypass method is performed (step S152).

Subsequently, the image processing apparatus 10 starts in the normal mode (step S153).

On the other hand, when the user, who has viewed the message displayed on the operation panel 15 in step S152, starts the application on the portable terminal 30, the main controller 41 in the portable terminal 30 controls the UI controller 42 to display on the touch panel 33 a message checking whether to overwrite the bypass settings (step S351).

Then, the main controller 41 controls the UI controller 42 to determine whether the user has selected an option to overwrite the bypass settings (step S352).

If it is determined that the user has selected the option to overwrite the bypass settings, the main controller 41 controls the communication controller 44 to transmit the preceding settings, which are stored in the preceding settings storage unit 43, to the image processing apparatus 10 (step S353). Specifically, the portable terminal 30 transmits the preceding settings to the image processing apparatus 10 via the wireless communication I/F 36.

Thus, the main controller 21 in the image processing apparatus 10 controls the communication controller 24 to receive the preceding settings from the portable terminal 30 (step S154). Specifically, the image processing apparatus 10 receives the preceding settings via the communication I/F 18. Then, the image processing apparatus 10 applies the preceding settings to the current image processing apparatus 10 settings (step S155). Specifically, the main controller 21 stores the preceding settings in the current settings storage unit 23.

When a user has handled a situation by changing a setting parameter, for example, by changing the printer settings on the client side, the main controller 41 controls the UI controller 42 to display guiding information for the user regarding the way to restore the setting parameter (step S354). In such a case, the guiding information that is displayed last in the step S310 for the same error and that relates to the way to change the setting parameter may be stored, and the user may be provided with guiding information regarding the way to restore the setting parameter, which is reversing the change in the setting parameter.

On the other hand, if the operation continues smoothly with the current bypass settings, the user may want to continue the operation without changing anything. Thus, if it is not determined in step S352 that the user has selected the option to overwrite the bypass settings, the preceding settings are deleted from the preceding settings storage unit 43 (step S355). That is, the current bypass settings are treated as lasting settings.

In the above description, it is assumed that the user starts the application on the portable terminal 30 in response to the detection of the repair completion of the image processing apparatus 10, but this is not to be considered as limiting. Overwriting the bypass settings in the case where repair detection is not required, such as a case where a fault is caused only by a setting mistake by a user, is also possible. Thus, the user may be allowed to start the application on the portable terminal 30 any time, and the portable terminal 30 may receive instructions to overwrite the bypass settings.

In the present exemplary embodiment, the portable terminal 30 reads an image processing apparatus 10 state stored before the bypass operation is performed and thereby determines the image processing apparatus 10 state realized before the bypass operation is performed, but this is not to be considered as limiting. For example, the portable terminal 30 may generate an image processing apparatus 10 state in accordance with particular information stored before the bypass operation is performed and may thereby determine the image processing apparatus 10 state realized before the bypass operation is performed. The particular information may be an operation history of the image processing apparatus 10. This is because tracing the operation history of the image processing apparatus 10 sometimes enables inference of the image processing apparatus 10 state realized before the bypass operation is performed. Alternatively, the particular information may be a current image processing apparatus 10 state. This is because, if an image processing apparatus 10 state is one of two states and the current image processing apparatus 10 state is one of the two states, it is inferred that the image processing apparatus 10 state realized before the bypass operation is performed, is the other of the two states.

In the present exemplary embodiment, the portable terminal 30 stores the preceding settings of the image processing apparatus 10, configures the bypass settings, and performs processing of overwriting the preceding settings when the bypass settings are no longer necessary, but this is not to be considered as limiting. For example, all the processes to be performed by the portable terminal 30 may be performed by the image processing apparatus 10. In such a case, a storage unit that is disposed in the image processing apparatus 10 and that corresponds to the preceding settings storage unit 43 is an example of a memory region in which image processing apparatus 10 settings are stored, a function that is performed by the image processing apparatus 10 and that corresponds to the function of the main controller 41 to store preceding settings in the preceding settings storage unit 43 is an example of a storing unit that stores image processing apparatus 10 settings in the memory region, and the operation panel 15 is an example of an output unit that outputs information.

### Non-Transitory Computer Readable Medium

Processing to be performed by the image processing apparatus 10 and the portable terminal 30 according to the present exemplary embodiment is, for example, provided by a non-transitory computer readable medium storing a program such as application software.

Specifically, a program that realizes the present exemplary embodiment may be understood to be a program that causes a computer to determine a computer state realized while a bypass operation to bypass a particular fault is not being performed and to change, when it is no longer necessary to perform the bypass operation while the bypass operation is being performed, a current computer state to the computer state that is determined by the determining and that is realized while the bypass operation is not being performed.

The program to realize the present exemplary embodiment may be provided via a communication unit or in a stored form in a recording medium, such as a compact-disc read-only memory (CD-ROM).

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a determining unit that determines an information processing apparatus state realized while a bypass operation to bypass a particular fault is not being performed; and
a changing unit that changes, when it is no longer necessary to perform the bypass operation while the bypass operation is being performed, a current information processing apparatus state to the information processing apparatus state that is determined by the determining unit and that is realized while the bypass operation is not being performed.

2. The information processing apparatus according to claim 1,
wherein the determining unit designates an information processing apparatus state realized before the bypass operation is performed as the information processing apparatus state realized while the bypass operation is not being performed.

3. The information processing apparatus according to claim 2,
wherein the determining unit reads an information processing apparatus state stored before the bypass operation is performed and thereby determines the information processing apparatus state realized before the bypass operation is performed.

4. The information processing apparatus according to claim 2,
wherein the determining unit generates an information processing apparatus state in accordance with particular information stored before the bypass operation is performed and thereby determines the information processing apparatus state realized before the bypass operation is performed.

5. The information processing apparatus according to claim 4,
wherein the particular information is an operation history of the information processing apparatus.

6. The information processing apparatus according to claim 4,
wherein the particular information is a current information processing apparatus state.

7. The information processing apparatus according to claim 1,
wherein the determining unit designates information processing apparatus settings effective while the bypass operation is not being performed as the information processing apparatus state realized while the bypass operation is not being performed, and
the changing unit changes current information processing apparatus settings to the information processing apparatus settings that are designated by the determining unit and that are effective while the bypass operation is not being performed.

8. The information processing apparatus according to claim 7, further comprising:
a storing unit that stores, in a memory region, information processing apparatus settings effective before the bypass operation is performed,
wherein the determining unit designates the information processing apparatus settings stored in the memory region by the storing unit as the information processing apparatus settings effective while the bypass operation is not being performed.

9. The information processing apparatus according to claim 8,
wherein the storing unit stores, in the memory region, information processing apparatus settings effective before the bypass operation is performed in accordance with manipulation by which an operator designates the bypass operation.

10. The information processing apparatus according to claim 1, further comprising:
an output unit that outputs information,
wherein the determining unit further determines a state of an apparatus other than the information processing apparatus, the state being realized while the bypass operation is not being performed, and
the output unit outputs information stating that a current state of the other apparatus is to be changed to the state of the other apparatus that is determined by the determining unit and that is realized while the bypass operation is not being performed.

11. An information processing system comprising:
a first information processing apparatus; and
a second information processing apparatus,
wherein the first information processing apparatus determines a second information processing apparatus state realized while a bypass operation to bypass a particular fault is not being performed, and
the second information processing apparatus changes, when it is no longer necessary to perform the bypass operation while the bypass operation is being performed, a current second information processing apparatus state to the second information processing apparatus state that is determined by the first information processing apparatus and that is realized while the bypass operation is not being performed.

12. The information processing system according to claim 11,
wherein the first information processing apparatus designates a second information processing apparatus state realized before the bypass operation is performed as the second information processing apparatus state realized while the bypass operation is not being performed.

13. The information processing system according to claim 12,
wherein the first information processing apparatus reads a second information processing apparatus state stored before the bypass operation is performed and thereby determines the second information processing apparatus state realized before the bypass operation is performed.

14. The information processing system according to claim 11,
wherein the first information processing apparatus designates second information processing apparatus settings effective while the bypass operation is not being performed as the second information processing apparatus state realized while the bypass operation is not being performed, and
the second information processing apparatus changes current second information processing apparatus settings to the second information processing apparatus settings that are designated by the first information processing apparatus and that are effective while the bypass operation is not being performed.

15. The information processing system according to claim 14,
wherein the first information processing apparatus stores, in a memory region, second information processing apparatus settings effective before the bypass operation is performed and designates the second information processing apparatus settings stored in the memory region as the second information processing apparatus settings effective while the bypass operation is not being performed.

16. The information processing system according to claim 11,
wherein the first information processing apparatus further determines a state of an apparatus other than the second information processing apparatus, the state being realized while the bypass operation is not being performed, and outputs information stating that a current state of the other apparatus is to be changed to the determined state of the other apparatus that is realized while the bypass operation is not being performed.

17. A non-transitory computer readable medium storing a program causing a computer to execute a process for information processing, the process comprising:
determining a computer state realized while a bypass operation to bypass a particular fault is not being performed; and
changing, when it is no longer necessary to perform the bypass operation while the bypass operation is being performed, a current computer state to the computer state that is determined by the determining and that is realized while the bypass operation is not being performed.
